(19) United States
(12) Patent Application Publication
(10) Pub. No.: US 2026/0343191 A1
(43) Pub. Date: Oct. 29, 2026

(54) MULTI-GATEWAY COLLABORATIVE MECHANICAL DATA MONITORING INTERNET OF THINGS SYSTEMS AND METHODS FOR SENSORS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Chang SU, Chengdu (CN); Yunbai CHEN, Chengdu (CN)

(73) Assignee: CHENGDU QINCHUAN IOT TECHNOLOGY CO., LTD., Chengdu (CN)

(21) Appl. No.: 19/681,019

(22) Filed: May 18, 2026

(30) Foreign Application Priority Data
Apr. 13, 2026 (CN) 202610475883.4

(51) Int. Cl. H04W 4/38; G08G 1/01; H04W 12/106; H04W 28/06

(52) U.S. Cl. CPC H04W 4/38; G08G 1/0112; G08G 1/0129; H04W 12/106; H04W 28/065

(57) ABSTRACT

Embodiments of the present disclosure provide an Internet of Things system and method. The method includes: collecting mechanical data, and converting the mechanical data of each leaf node into a frequency signal; aggregating frequency signals, and segmenting a data packet containing the frequency signals into a plurality of data fragments of preset length; sending the data fragments to the sensing network platform; broadcasting status information of the heterogeneous gateways; parsing the frequency signals from the received data fragments, converting the frequency signals back to the mechanical data; performing data reassembly and an integrity check on the received mechanical data; in response to determining that a data fragment loss and/or a check failure is detected, sending a local retransmission instruction to the perception control platform; and controlling a computer terminal to render and generate an axial force trend graph and/or a torque trend graph based on the complete mechanical data.

### CROSS-REFERENCE TO RELATED APPLICATIONS

This application claims the priority of Chinese Patent Application No. 202610475883.4, filed on Apr. 13, 2026, the contents of which are hereby incorporated by reference.

### TECHNICAL FIELD

The present disclosure generally relates to the field of data monitoring, and in particular to a multi-gateway collaborative mechanical data monitoring Internet of Things (IoT) system and method for sensors.

### BACKGROUND

Traditional monitoring of rotating shaft systems often adopts analog signal wired transmission or single-gateway wireless transmission, which is prone to situations such as network cable wear and breakage, or packet loss caused by strong electromagnetic interference in factories. Moreover, traditional monitoring of rotating shaft systems typically adopts an entire-packet retransmission mechanism during packet loss retransmission, which is likely to cause network congestion and data latency in high-interference and high-load environments, failing to meet real-time and reliability requirements of key mechanical data.

Based on this, it is desirable to provide a multi-gateway collaborative mechanical data monitoring Internet of Things (IoT) system for sensors and a multi-gateway collaborative mechanical data monitoring method for sensors, which can ensure the reliable collection of non-contact sensor data in high-intensity electromagnetic interference environments, and realize the precise reassembly and integrity check of data after multi-gateway parallel transmission, so as to meet reliability requirements of engineering safety monitoring.

### SUMMARY

One or more embodiments of the present disclosure provide a multi-gateway collaborative mechanical data monitoring Internet of Things system for sensors. The system includes a perception control platform, a sensing network platform, and a management platform. The perception control platform includes at least one set of non-contact sensors deployed on a driving shaft or a supporting shaft, the non-contact sensors form a tree network. The sensing network platform includes at least one set of heterogeneous gateways supporting different transmission protocols. The management platform includes a computer terminal. The perception control platform is configured to: collect mechanical data through leaf nodes of the tree network, and convert the mechanical data into a frequency signal; aggregate the frequency signal through routing nodes of the tree network, and segment a data packet containing the frequency signal into a plurality of data fragments of preset length; send the data fragments to the sensing network platform; the sensing network platform is configured to: broadcast status information of the heterogeneous gateways according to a preset period; parse the frequency signal from the received data fragments, convert the frequency signal back to the mechanical data, and send the mechanical data to the management platform; the management platform is configured to: perform data reassembly and an integrity check on the received mechanical data; in response to determining that a data fragment loss and/or a check failure is detected, send a local retransmission instruction to the perception control platform; send the complete mechanical data to the computer terminal, and control the computer terminal to render and generate at least one of an axial force trend graph or a torque trend graph.

One or more embodiments of the present disclosure provide a multi-gateway collaborative mechanical data monitoring method for sensors. The method is implemented by a multi-gateway collaborative mechanical data monitoring Internet of Things system for sensors. The system includes a perception control platform, a sensing network platform, and a management platform. The perception control platform includes at least one set of non-contact sensors deployed on a driving shaft or a supporting shaft. The non-contact sensors form a tree network. The sensing network platform includes at least one set of heterogeneous gateways supporting different transmission protocols. The management platform includes a computer terminal. The method includes: collecting mechanical data through leaf nodes of the tree network, and converting the mechanical data into a frequency signal; aggregating the frequency signal through routing nodes of the tree network, and segmenting a data packet containing the frequency signal into a plurality of data fragments of preset length; sending, by the perception control platform, the data fragments to the sensing network platform; broadcasting status information of the heterogeneous gateways according to a preset period; parsing the frequency signal from the received data fragments, converting the frequency signal back to the mechanical data, and sending the mechanical data to the management platform; performing data reassembly and an integrity check on the received mechanical data; in response to determining that at least one of a data fragment loss or a check failure is detected, sending a local retransmission instruction to the perception control platform; sending the complete mechanical data to the computer terminal, and controlling the computer terminal to render and generate at least one of an axial force trend graph or a torque trend graph.

One or more embodiments of the present disclosure provide a non-transitory computer-readable storage medium. The storage medium stores computer instructions that, when executed by a processor, cause the processor to implement the multi-gateway collaborative mechanical data monitoring method for sensors.

### BRIEF DESCRIPTION OF THE DRAWINGS

The present disclosure is further described in an illustrative manner by way of exemplary embodiments. These exemplary embodiments are described in detail with reference to the accompanying drawings. These embodiments are not restrictive. In these embodiments, the same reference numerals denote the same structures, wherein:

FIG. 1 is a schematic diagram illustrating an exemplary structure of a multi-gateway collaborative mechanical data monitoring Internet of Things system for sensors according to some embodiments of the present disclosure;

FIG. 2 is an exemplary flowchart of a multi-gateway collaborative mechanical data monitoring method for sensors according to some embodiments of the present disclosure;

FIG. 3 is a schematic diagram illustrating an exemplary traffic prediction model according to some embodiments of the present disclosure; and

FIG. 4 is a schematic diagram illustrating an exemplary score prediction model according to some embodiments of the present disclosure.

### DETAILED DESCRIPTION

To more clearly illustrate technical solutions of embodiments of the present disclosure, accompanying drawings used in the description of the embodiments are briefly introduced below. Obviously, the accompanying drawings in the following description are merely some examples or embodiments of the present disclosure. For a person of ordinary skill in the art, the present disclosure may be applied to other similar scenarios based on these accompanying drawings without creative efforts. Unless obviously obtained from the context or the context illustrates otherwise, the same numeral in the drawings refers to the same structure or operation.

It should be understood that the terms “system,” “device,” “unit,” and/or “module” used herein are a method for distinguishing different components, elements, parts, sections, or assemblies of different levels. However, if other words can achieve the same purpose, the words may be replaced by other expressions.

As shown in the present disclosure and the claims, unless the context clearly indicates an exception, the words “a,” “an,” “one,” and/or “the” are not limited to a singular form and may also include a plural form. Generally, the terms “include” and “contain” only indicate inclusion of clearly identified steps and elements, and these steps and elements do not constitute an exclusive list. A method or device may also include other steps or elements.

Flowcharts are used in the present disclosure to illustrate operations performed by a system according to embodiments of the present disclosure. It should be understood that preceding or following operations are not necessarily performed precisely in order. On the contrary, each step may be processed in reverse order or simultaneously. Meanwhile, other operations may be added to these processes, or one or more operations may be removed from these processes.

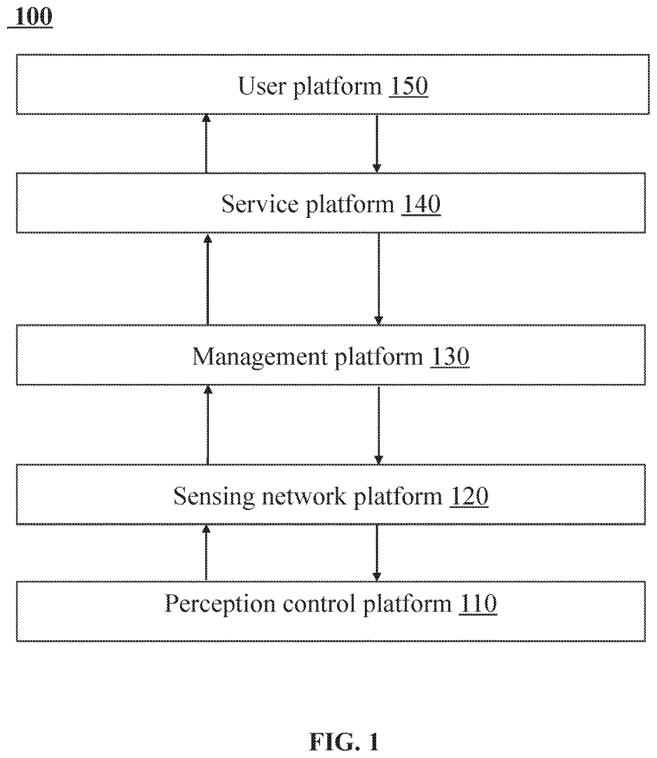

FIG. 1 is a schematic diagram illustrating an exemplary structure of a multi-gateway collaborative mechanical data monitoring Internet of Things system for sensors according to some embodiments of the present disclosure.

In some embodiments, as shown in FIG. 1, the multi-gateway collaborative mechanical data monitoring Internet of Things system for sensors (hereinafter referred to as the system) 100 may include a perception control platform 110, a sensing network platform 120, and a management platform 130.

The perception control platform 110 refers to a platform for data acquisition and preliminary data processing. The perception control platform 110 may be constituted by at least one set of sensors and nodes with integrated communication functions. In some embodiments, the perception control platform 110 includes at least one set of non-contact sensors deployed on a driving shaft or a supporting shaft.

The driving shaft or the supporting shaft refers to a shaft-type structural component used for transmitting power or bearing loads in engineering applications. For example, the driving shaft or the supporting shaft may be a shaft in construction machinery, a wind turbine generator, or a bridge structure.

The non-contact sensor refers to a sensor that may obtain physical data without directly contacting a measured object. For example, the non-contact sensor may include a vibrating wire axial force meter, a torque sensor, a multi-axis force sensor, or the like. The non-contact sensor may obtain mechanical data by sensing physical deformation and directly convert the mechanical data into a frequency signal for output.

In some embodiments, the non-contact sensors form a tree network. The tree network refers to a hierarchical network topology structure, including leaf nodes for data acquisition and routing nodes for data processing. For example, leaf nodes in the network are responsible for data acquisition, and routing nodes are responsible for data processing, including data aggregation, relay forwarding, and data fragmentation.

In some embodiments, the leaf nodes may deploy the non-contact sensor, and the routing nodes may deploy radio frequency chips. In some embodiments, deployment positions of the leaf nodes and the routing nodes may be determined through on-site survey and signal strength testing. For example, a technician evaluates a physical layout of the driving shaft or the supporting shaft on site, and deploys the leaf nodes directly on an axis body that needs to be monitored to ensure accurate mechanical data acquisition. The routing nodes are deployed in an area that can cover all the leaf nodes and has minimal signal interference based on the quantity, distribution, and communication distance of the leaf nodes to optimize a data transmission link.

In some embodiments, the perception control platform 110 is configured to collect the mechanical data through leaf nodes of the tree network and convert the mechanical data into frequency signals; aggregate the frequency signals through routing nodes of the tree network, and segment a data packet containing the frequency signals into a plurality of data fragments of preset length; and send the data fragments to the sensing network platform 120.

The sensing network platform 120 refers to a platform for sensing communication, and is configured to implement bidirectional data interaction and communication transmission between the management platform 130 and the perception control platform 110. In some embodiments, the sensing network platform 120 may include at least one set of heterogeneous gateways supporting different transmission protocols.

The heterogeneous gateway refers to a device supporting a plurality of different transmission protocols. The transmission protocol is a set of rules for network communication. For example, the different transmission protocols may include 4G, 5G, WiFi, Ethernet, or the like.

In some embodiments, the heterogeneous gateways are configured to receive frequency signals from the perception control platform 110, parse the frequency signals, and transmit data in parallel through transmission protocols. The sensing network platform 120 may store historical operation logs of the heterogeneous gateways. The historical operation log refers to a data set recording operation conditions of a heterogeneous gateway, for example, a packet loss rate, an average latency, or the like.

In some embodiments, the sensing network platform 120 is configured to broadcast status information of heterogeneous gateways according to a preset period. The sensing network platform 120 parses the frequency signal from received data fragments, converts the frequency signal back to the mechanical data, and sends the mechanical data to the management platform 130.

In some embodiments, a data processing module may be built into the heterogeneous gateways to process received data fragments. For example, the data processing module may be a message queuing telemetry transport (MQTT) data processing module.

The management platform 130 refers to a backend processing center of the system 100. The management platform 130 is configured to receive a data stream, perform data processing and checking, or the like. In some embodiments, the management platform 130 may provide a user interface. Content of the user interface may include an axial force trend graph and/or a torque trend graph.

In some embodiments, the management platform 130 may include a processor, a server, and a computer terminal.

The processor may process data and/or information obtained from other devices or system components. The processor may execute program instructions based on the data, the information, and/or processing results to perform one or more functions described in the present disclosure. In some embodiments, the processor may include one or more sub-processing devices (e.g., a single-core processing device or a multi-core multi-chip processing device).

In some embodiments, the management platform 130 is configured to perform data reassembly and an integrity check on received mechanical data. In response to determining that a data fragment loss and/or a check failure is detected, the management platform 130 sends a local retransmission instruction to the perception control platform. The management platform 130 sends complete mechanical data to the computer terminal, and controls the computer terminal to render and generate an axial force trend graph and/or a torque trend graph.

In some embodiments, as shown in FIG. 1, the system 100 may further include a service platform 140 and a user platform 150. The service platform 140 refers to a platform that provides services to a user. In some embodiments, the service platform 140 may be configured as a server, a gateway, a router, or the like. The user platform 150 refers to a platform that interacts with the user. In some embodiments, the user platform 150 may be configured as a terminal device, for example, a smartphone, a tablet computer, a personal computer (PC), a smart watch, or the like. The service platform 140 may exchange data or information with the management platform 130 and the user platform 150.

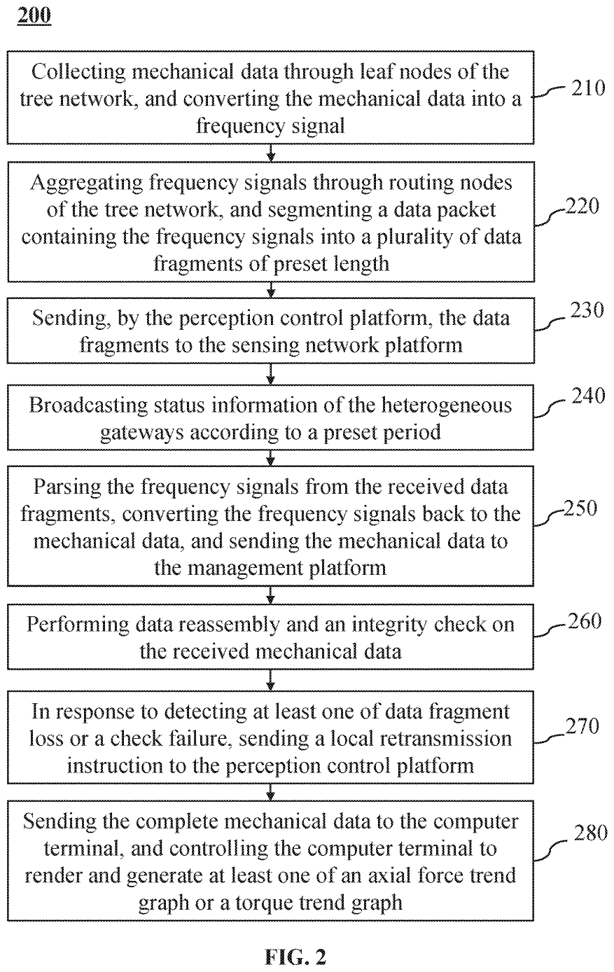

More descriptions of the above content may be found in FIG. 2 to FIG. 4 and related descriptions.

In some embodiments of the present disclosure, the multi-gateway collaborative mechanical data monitoring Internet of Things system 100 may form an information operation closed loop among various functional platforms. Under unified management of the management platform 130, the sensing network platform 120, and the perception control platform 110, the system 100 may operate in a coordinated and regular manner to achieve informatization and intelligence of multi-gateway collaborative mechanical data monitoring.

FIG. 2 is an exemplary flowchart of a multi-gateway collaborative mechanical data monitoring method for sensors according to some embodiments of the present disclosure. As shown in FIG. 2, a process 200 includes steps 210 to 280. Steps 210 to 230 are performed by a perception control platform. Steps 240 to 250 are performed by a sensing network platform. Steps 260 to 280 are performed by a management platform.

In step 210, mechanical data is collected through leaf nodes of the tree network, and the mechanical data is converted into a frequency signal.

More descriptions of the tree network may be found in FIG. 1 and related descriptions. The tree network includes leaf nodes and routing nodes.

The leaf node refers to a node in the tree network that is responsible for data collection and upward transmission. For example, leaf nodes may deploy non-contact sensors to collect the mechanical data and switch to a collection mode in response to a frequency conversion control instruction.

The routing node refers to a node in the tree network that has functions of data aggregation, relay forwarding, and data fragmentation. For example, the routing node may receive frequency signals from a plurality of sensors and aggregate the frequency signals into a complete data packet.

In some embodiments, the perception control platform may use the plurality of sensors in at least one set of non-contact sensors (abbreviated as sensors) as a plurality of leaf nodes of the tree network. After sensors at the leaf nodes are started, the perception control platform automatically completes self-organizing networking through integrated radio frequency chips to form the tree network. In some embodiments, the perception control platform may use a plurality of radio frequency chips as a plurality of routing nodes. The routing node may serve as an aggregation point to aggregate frequency signals received from the plurality of sensors into a complete data packet.

The mechanical data refers to a physical quantity obtained by a sensor through sensing physical deformation, i.e., a physical deformation value. For example, the mechanical data is an axial force, a torque, or a multi-axis force.

In some embodiments, the non-contact sensor inside the leaf node is deployed on a driving shaft or a supporting shaft. The non-contact sensor collects the mechanical data in real time by sensing the physical deformation of a shaft body. The sensor may convert the collected mechanical data into a frequency signal through an internal circuit.

The frequency signal refers to a signal that carries information through frequency variation. The frequency signal has excellent anti-interference performance in an industrial environment. For example, the frequency signal may be a signal output by converting a physical deformation value into a vibration frequency.

In some embodiments, the sensor internally integrates a signal processing circuit, for example, an oscillation circuit, to convert a physical deformation value corresponding to the collected mechanical data into a frequency signal proportional to the physical deformation value. This conversion utilizes the stability of the frequency signal in the time domain and can effectively resist interference from motor magnetic fields and electromagnetic noise in a factory environment.

In some embodiments, the sensor in the leaf node may transmit the frequency signal that is collected and converted to the routing node for subsequent processing.

In some embodiments of the present disclosure, the tree network is automatically constructed through sensors and radio frequency chips in the perception control platform, achieving an efficient and reliable data transmission path. By deploying the non-contact sensors at leaf nodes of the tree network to collect the mechanical data and convert the mechanical data into frequency signals with strong anti-interference capability, the interference from motor magnetic fields and electromagnetic noise in a factory environment is effectively resisted, significantly improving the accuracy of the mechanical data collection and the reliability of the system in a complex industrial environment.

In some embodiments, the perception control platform may be configured to determine a data type of the mechanical data corresponding to the frequency signal according to a frequency value of the frequency signal. The data type includes key mechanical data and ordinary mechanical data.

The frequency value refers to a numerical value of the frequency signal. The magnitude of the frequency value reflects the magnitude of a mechanical load (e.g., an axial force or a torque) borne by the driving shaft or the supporting shaft where the non-contact sensor is deployed.

The key mechanical data refers to mechanical data indicating that the driving shaft or the supporting shaft may be in an abnormal or critical state. For example, the key mechanical data indicates that the driving shaft is subjected to an abnormal load, a sudden impact, or has entered a fault warning state. The key mechanical data is high-priority data that requires real-time and highly reliable transmission.

The ordinary mechanical data refers to mechanical data indicating that the driving shaft or the supporting shaft is in a normal or stable operating state. For example, the ordinary mechanical data may be used for periodic trend analysis and has a lower priority compared to the key mechanical data.

In some embodiments, after receiving the frequency signal, the routing node in the perception control platform compares the frequency value of the frequency signal with a first preset threshold in real time. The first preset threshold refers to a preset upper limit value of frequency, corresponding to a critical mechanical load. The first preset threshold may be preset by an engineer according to the design safety specifications of related equipment and operational environment experience.

In some embodiments, the perception control platform may be configured to: in response to the frequency value of the frequency signal being greater than the first preset threshold, mark the mechanical data corresponding to the frequency signal as the key mechanical data; or in response to the frequency value of the frequency signal being less than or equal to the first preset threshold, mark the mechanical data corresponding to the frequency signal as the ordinary mechanical data.

In response to determining that the frequency value of the frequency signal is greater than the first preset threshold, the routing node determines that the corresponding mechanical data is the key mechanical data. This indicates that the driving shaft or the supporting shaft may be subjected to an abnormal load or a sudden impact. In response to determining that the frequency value of the frequency signal is less than or equal to the first preset threshold, the routing node determines that the corresponding mechanical data is ordinary mechanical data. This indicates that the driving shaft or the supporting shaft is in a normal or stable operating state.

In some embodiments, the routing node may embed a specific identifier (e.g., “urgent” or “routine”) in a data packet when constructing the data packet to indicate that the mechanical data in the data packet is the key mechanical data or the ordinary mechanical data.

In some embodiments of the present disclosure, by comparing the frequency signal value with a preset threshold at a data source, the mechanical data is marked in real time with a grade, thereby distinguishing the mechanical data into the key mechanical data and the ordinary mechanical data. This provides a clear priority basis for subsequent transmission and processing, ensuring that abnormal or high-risk data can be prioritized for identification and processing, thereby improving the system's warning response speed to potential faults.

In some embodiments, the first preset threshold is dynamically adjusted according to an environmental drift component. The perception control platform may be configured to: obtain a median value of frequency variation values of the at least one set of non-contact sensors to determine the environmental drift component; and update the first preset threshold according to the environmental drift component.

A frequency variation value refers to a difference between frequency signals collected by the sensor at different time points, reflecting frequency fluctuation caused by a mechanical load or environmental factors.

A median value refers to a numerical value at a middle position after a set of data is sorted from smallest to largest. Compared to an average value, the median value is more resistant to influence from a sudden failure of a single sensor or local interference.

In some embodiments, the routing node in the perception control platform aggregates frequency signals collected from at least one set of non-contact sensors (i.e., the plurality of leaf nodes) on the same driving shaft within the same time window. The routing node calculates the frequency variation value for each sensor, i.e., a difference between a current frequency value and a previous frequency value, performs statistical analysis on the frequency variation value of each sensor, and calculates a median value of all frequency variation values. For example, the routing node may utilize a stored statistical analysis algorithm to sort the frequency variation values and select a numerical value at a middle position as the median value.

The environmental drift component refers to a numerical value reflecting the influence of environmental factors (e.g., temperature, electromagnetic noise) on the consistency of frequency signals collected by sensors. For example, the environmental drift component may be a median value or calculated based on a median value.

In some embodiments, the routing node may determine a calculated median value as the current environmental drift component. For example, the routing node directly assigns the median value to the environmental drift component. In some embodiments, the environmental drift component may also be determined by multiplying a median value by a preset empirical coefficient. The empirical coefficient may be positively correlated with a deviation amplitude between multiple calculation results of the median value and an average value of the median value, to further optimize the compensation accuracy.

In some embodiments, the routing node in the perception control platform may perform real-time linear compensation on an originally fixed first preset threshold according to the determined environmental drift component, thereby obtaining an updated first preset threshold. For example, the updated first preset threshold may be the original first preset threshold plus the environmental drift component. In some embodiments, the first preset threshold may also be updated in other ways. For example, an adaptive algorithm may be used to adjust the first preset threshold, or predictive updating may be performed in combination with historical environmental drift data.

In some embodiments of the present disclosure, by calculating and compensating for the environmental drift component in real time, the first preset threshold can be dynamically adjusted. This effectively eliminates interference from environmental factors such as temperature and overall electromagnetic background noise on a monitoring baseline. This significantly reduces the false alarm rate of the system and the probability of misjudging the “key mechanical data”. This improves the accuracy of data determination.

In some embodiments, the perception control platform is further configured to: in response to a determination that the data type of the mechanical data corresponding to the frequency signal is the key mechanical data, send a frequency conversion control instruction to the leaf node that collects the mechanical data. The frequency conversion control instruction controls the leaf node to switch from a low-frequency mode to a high-frequency mode to collect physical deformation details of the supporting shaft and/or the driving shaft.

In some embodiments, when the perception control platform detects an anomaly (e.g., detects the key mechanical data), the perception control platform may control a sensor to quickly switch from a low-power mode to a high-precision mode to obtain complete fault details. For example, when the routing node identifies that the mechanical data collected by the leaf node is marked as the key mechanical data, this indicates that the supporting shaft and/or the driving shaft may have experienced a sudden change or an abnormal condition. The routing node then needs to switch to the high-frequency mode to collect physical deformation details more densely.

The frequency conversion control instruction refers to an instruction for controlling the sensor of the leaf node to change the working frequency or the collection mode of the sensor. For example, the frequency conversion control instruction may be the data packet containing a specific operation code and an address of the leaf node. The routing node may immediately send the frequency conversion control instruction to a specific leaf node that has collected the key mechanical data after discovering the key mechanical data.

The low-frequency mode refers to an operating mode in which a sensor performs data collection at a lower sampling frequency. Under normal conditions, the sensor operates in the low-frequency mode. For example, a sampling frequency range of the low-frequency mode may be from 10 Hz to 50 Hz. The low-frequency mode is typically used to maintain low-power operation, which can extend battery life. The high-frequency mode refers to an operating mode in which a sensor performs data collection at a higher sampling frequency. For example, a sampling frequency range of the high-frequency mode may be from 1 kHz to 10 KHz. The high-frequency mode is used to collect deformation data more densely to record fault details, ensuring complete recording of physical deformation details (such as impact waveforms, high-frequency vibration characteristics) at the moment a fault or anomaly occurs.

In some embodiments, once the routing node in the perception control platform determines that the data type is key mechanical data, the routing node immediately sends the frequency conversion control instruction to a specific leaf node that collected the mechanical data via a radio frequency chip. For example, the routing node may send the frequency conversion control instruction to the specific leaf node through a preset priority communication channel. To ensure reliability of the instruction, the routing node may employ a retransmission mechanism or an acknowledgment/response mechanism.

The physical deformation details refer to the subtle change characteristics of the shaft body deformation when an abnormal condition or fault occurs. For example, the physical deformation details include impact waveforms, high-frequency vibration characteristics, or the like.

In some embodiments, after receiving the frequency conversion control instruction sent by the routing node, the leaf node switches a sampling frequency of the sensor from a default low-frequency mode (e.g., 10 Hz to 50 Hz) to a high-frequency mode (e.g., 1 kHz to 10 kHz). As another example, the leaf node may integrate two independent sensors internally, corresponding to the low-frequency mode and the high-frequency mode, respectively. When the frequency conversion control instruction is received, the leaf node activates the sensor for the high-frequency mode and deactivates the sensor for the low-frequency mode.

In some embodiments, after the leaf node switches to the high-frequency mode, the sensor may collect data at a denser frequency (e.g., 1 kHz), thereby capturing physical deformation details that might be missed in the low-frequency mode. For example, when an impact occurs, the high-frequency mode may record detailed data of a rising edge, a peak, and a decay process of an impact waveform. As another example, in the high-frequency mode, the sensor may more accurately capture high-frequency vibration characteristics, which can indicate bearing wear, gear damage, or other structural faults. The collected physical deformation details may be short-term strain rate changes, impact response curves, or high-frequency harmonic components.

In some embodiments of the present disclosure, when the key mechanical data is detected, the perception control platform may quickly trigger the leaf node to switch from the default low-frequency mode to the high-frequency mode. The leaf node densely collects physical deformation details of the supporting shaft or the driving shaft to effectively capture key fault information that may be lost during low-frequency collection. This ensures monitoring accuracy while, through the default low-frequency mode, also taking into account low-power operation and battery life management of the system. This achieves adaptive, on-demand collection for the sensors.

In step 220, the frequency signals are aggregated through routing nodes of the tree network, and a data packet containing the frequency signals is segmented into a plurality of data fragments of preset length.

In some embodiments, the routing node has a built-in radio frequency chip that receives frequency signals from the plurality of leaf nodes. The routing node encapsulates these independent frequency signals into a unified data structure to form the complete data packet. For example, the routing node may periodically poll or passively receive frequency signals sent from its subordinate leaf nodes, and package the frequency signals after receiving all of a predetermined count of frequency signals. The predetermined count may be preset based on experience.

The data packet refers to a complete data set that aggregates frequency signals from a plurality of sensors.

The data fragment refers to a transmission unit generated by dividing the data packet. For example, a header of each data fragment is encapsulated with a unique identifier of the data packet, a sequence number of the data fragment, and a check code.

The unique identifier of the data packet refers to an identifier used for data reassembly and classification. The sequence number of the data fragment refers to an identifier used for ordering and checking integrity. The check code refers to a code used to verify whether the content of the fragment is corrupted during transmission.

In some embodiments, before sending the data packet to the sensing network platform, the routing node of the perception control platform segments the aggregated data packet according to a preset length (e.g., a preset byte length or data volume). Each generated data fragment is automatically appended with a unique identifier of the corresponding data packet, a sequence number of the data fragment, and check code information for a subsequent integrity check. For example, the routing node may adopt a data link layer or network layer protocol (e.g., a segmentation mechanism of a transmission control protocol/internet protocol (TCP/IP) protocol stack) to segment upper-layer application data into smaller data units processable by the network layer and embed protocol header information in each unit. In some embodiments, the preset length may be configured according to a maximum transmission unit (MTU) of the network or a buffer capacity of a target gateway to optimize the transmission efficiency and reduce the packet loss rate.

In some embodiments of the present disclosure, the routing node in the tree network aggregates frequency signals from the plurality of sensors, assembles the frequency signals into the complete data packet, and segments the complete data packet into data fragments of the preset length with a unique identifier, a sequence number, and a check code. This fragmentation mechanism optimizes data transmission efficiency, helps resist occasional errors in network transmission, and lays a foundation for the subsequent data reassembly and the integrity check by the management platform.

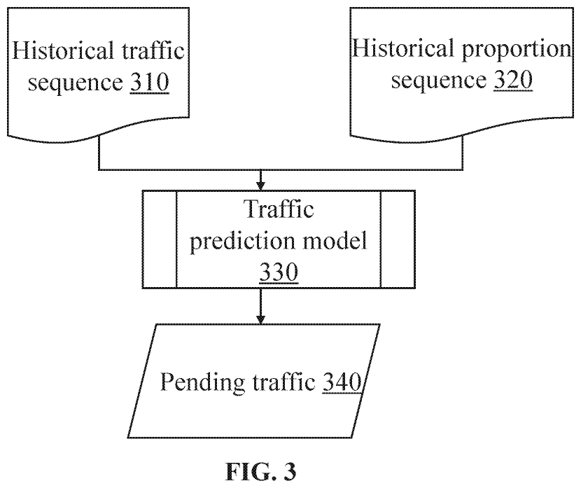

FIG. 3 is a schematic diagram illustrating an exemplary traffic prediction model according to some embodiments of the present disclosure.

In some embodiments, the perception control platform is further configured to predict pending traffic 340 in a future period based on a historical traffic sequence 310 and a historical proportion sequence 320 of key mechanical data according to a traffic prediction model 330; and adjust a preset length of a data fragment according to the pending traffic 340 in the future period.

The historical traffic sequence refers to a sequence composed of data aggregated and actually sent by the routing node within a historical time period. The historical time period may be divided into a plurality of time windows. The historical traffic sequence reflects a data volume trend of historical data, for example, periodic traffic fluctuations of heterogeneous gateways on a daily basis. The historical traffic sequence is a traffic sequence counted since the last adjustment of the preset length of the data fragment.

The historical proportion sequence of the key mechanical data refers to a proportion of data marked as the key mechanical data in the historical traffic sequence within the historical time period. The historical proportion sequence reflects whether a leaf node switches to a high-frequency mode.

In some embodiments, the routing node in the perception control platform continuously records and analyzes traffic conditions of the routing node, and the historical traffic sequence and the historical proportion sequence may be obtained based on historical records of the routing node. The historical traffic sequence and the historical proportion sequence are used to train and run the traffic prediction model. The traffic prediction model infers total pending traffic that may occur in the next period or a plurality of future time windows by analyzing historical change patterns and periodicity of these sequences.

The pending traffic in the future period refers to a predicted traffic value to be sent in the future period. The future period may be divided into one or more time windows. The pending traffic includes not only regular periodic traffic but also predicts potential traffic surges caused by persistent anomalies of heterogeneous gateways or mode changes of leaf nodes.

The traffic prediction model refers to a model used to determine the pending traffic. In some embodiments, the traffic prediction model is a machine learning model. For example, the traffic prediction model includes one or a combination of a time series model, a neural network (NN) model, a recurrent neural network (RNN) model, a long short-term memory (LSTM) network model, or other customized models.

In some embodiments, an input of the traffic prediction model may include the historical traffic sequence and the historical proportion sequence of the key mechanical data, and an output of the traffic prediction model may include the pending traffic in the future period.

In some embodiments, the traffic prediction model may be obtained based on training data. In some embodiments, the perception control platform may obtain a first training sample set composed of a plurality of first training samples with first labels, and perform multiple rounds of iterations based on the first training sample set.

The first training sample may include a sample historical traffic sequence and a sample historical proportion sequence of the key mechanical data. The first label is pending traffic in the future period corresponding to the first training sample. The first training sample and the first label may be obtained through historical data. The perception control platform may read a historical traffic sequence in historical data and a historical proportion sequence of the key mechanical data collected within a first time period as the first training sample; obtain a data volume sent within a second time period in the historical data as a historical traffic; and select an average value of historical traffic meeting a preferred condition as the first label corresponding to the first training sample. The second time period may include one or more time periods.

In some embodiments, the preferred condition may be that no network anomaly occurs after data is sent. The network sending anomaly may include network congestion, a sudden drop in efficiency, or severe fluctuations. A time length of the first time period is the same as a time length of the historical time period, a time length of the second time period is the same as a time length of the future period, and the first time period is earlier than the second time period.

In some embodiments, the processor may input the first training sample set into an initial traffic prediction model to perform multiple rounds of iterations. At least one round of iteration includes: selecting one or more first training samples from the first training sample set; inputting the one or more first training samples into the initial traffic prediction model to obtain model prediction outputs corresponding to the one or more first training samples; substituting the model prediction outputs corresponding to the one or more first training samples and the first labels of the one or more first training samples into a formula of a predefined loss function to calculate a value of the loss function; and iteratively updating model parameters in the initial traffic prediction model according to the value of the loss function until an iteration end condition is met, and ending the iteration to obtain a trained traffic prediction model. The iteration end condition may include convergence of the loss function, a number of iterations reaching a threshold, or the like.

In some embodiments, the perception control platform may determine whether the pending traffic satisfies an adjustment condition. The adjustment condition may include that a degree to which the pending traffic exceeds a traffic average threshold exceeds a preset degree. The preset degree may be preset based on experience, for example, 25%. The traffic average threshold refers to an average value of traffic in historical data and may be determined based on the historical data.

In some embodiments, in response to the pending traffic satisfying the adjustment condition, the perception control platform may control the routing node to dynamically reduce the preset length of the data fragment. For example, the perception control platform may divide the data fragment into two sub-fragments, and a preset length of each sub-fragment is half of the preset length of the data fragment; after execution, input the historical traffic sequence and the historical proportion sequence of the key mechanical data into the traffic prediction model to obtain the pending traffic in the future period; in response to the pending traffic satisfying the adjustment condition, continue to segment each sub-fragment; and repeat the above process until the pending traffic does not satisfy the adjustment condition. Although a total data volume does not change after the data fragment is further divided, the smaller the data fragment, the smaller the negative impact of network congestion on data transmission, and the smaller the retransmission cost, and accordingly, the historical traffic sequence changes.

In some embodiments, in response to the pending traffic not satisfying the adjustment condition, the perception control platform may control the routing node to keep the preset length of the data fragment unchanged. In some embodiments, in response to a duration in which the pending traffic does not satisfy the adjustment condition reaching a preset duration, the perception control platform may control the routing node to appropriately increase the preset length of the data fragment based on a preset amplitude. The preset duration may be determined based on experience. The preset amplitude refers to an adjustment amplitude for adjusting the preset length of the data fragment and is negatively correlated with the fluctuation amplitude of the pending traffic. For example, the perception control platform may determine the preset amplitude based on a first preset formula. The first preset formula may be expressed as L1=1−L2. L1 is the preset amplitude, and L2 is the fluctuation amplitude of the pending traffic.

In some embodiments of the present disclosure, by predicting pending traffic in a future period based on the historical traffic sequence and the historical proportion sequence of the key mechanical data, a prediction of future network congestion is achieved. By appropriately increasing the length of the data fragment, a quantity of the data fragments and the overhead of header information can be reduced when network conditions are good, thereby improving transmission efficiency and a data throughput rate. By reducing the length of the data fragment, the cost of a single retransmission can be reduced, and the transmission success rate can be improved. By actively adjusting the size of the data fragment based on the pending traffic in the future period, network management can be upgraded from passive response to active optimization, thereby maximizing network throughput efficiency while ensuring data robustness in a high-interference environment.

In step 230, the data fragments are sent by the perception control platform to the sensing network platform.

More descriptions about the sensing network platform may be found in FIG. 1 and related descriptions.

In some embodiments, the routing node in the perception control platform sends the divided data fragment to the sensing network platform via a radio frequency chip using a wireless communication protocol (e.g., LoRa or ZigBee). The routing node may dynamically select a transmission path according to status information received from heterogeneous gateways. For example, the routing node may select a heterogeneous gateway with the highest signal strength or the best link quality as a target for transmission according to a preset signal strength threshold.

In some embodiments, before sending the data fragment, the routing node queries the cached status information of heterogeneous gateways and selects a heterogeneous gateway with the lowest CPU load rate and sufficient remaining power as a target for transmission to achieve load balancing.

More descriptions about the status information of the heterogeneous gateways may be found in step 240 and related descriptions.

In some embodiments, the perception control platform may be further configured to calculate a real-time composite score of a heterogeneous gateway by weighted calculation based on the status information of the heterogeneous gateway. According to the real-time composite score, the perception control platform controls the data fragment to perform differentiated transmission.

The real-time composite score refers to a numerical value reflecting a current service quality and reliability of the heterogeneous gateway. For example, the real-time composite score may be obtained by a weighted calculation of signal strength, a CPU load rate, and remaining power.

In some embodiments, the routing node in the perception control platform receives the status information periodically broadcast from each heterogeneous gateway. More descriptions about the periodic broadcast of the heterogeneous gateway may be found in step 240 and related descriptions. The status information includes three parameters: a CPU load rate, signal strength, and remaining power. The routing node employs a weighted decision algorithm to perform normalization processing and weighted calculation on the status parameters, thereby obtaining a current real-time composite score of each heterogeneous gateway. For example, the routing node may perform normalization processing on the three status parameters respectively, multiply the normalized status parameters by corresponding weights respectively, and finally use a sum of the three products as the real-time composite score. As used herein, a weight of the status parameter is a scoring weight set based on experience, the weight of the signal strength is positive, the weight of the CPU load rate is negative, and the weight of the remaining power is positive.

In some embodiments, the perception control platform may further determine the real-time composite score of the heterogeneous gateway based on a score prediction model. For a specific determination manner, please refer to the related descriptions below.

In some embodiments, the routing node allocates the data fragments to different heterogeneous gateways according to the calculated real-time composite score and the data type of the mechanical data (the key mechanical data or the ordinary mechanical data), thereby achieving refined load balancing and priority guarantee.

In some embodiments, the routing node screens out heterogeneous gateways whose real-time composite scores are higher than a second preset threshold as a current available gateway set. The second preset threshold refers to a qualification line for the real-time composite score, ensuring that only heterogeneous gateways with good performance are used for data transmission. For example, the second preset threshold is a score of 60. The routing node traverses real-time composite scores of all heterogeneous gateways, and excludes heterogeneous gateways whose real-time composite scores are lower than the second preset threshold (e.g., the real-time composite score is lower than 60). The routing node may further allocate the data fragment to heterogeneous gateways in the available gateway set according to the data type of the data fragment.

In some embodiments, the second preset threshold may be dynamically adjusted according to the severity of the overall electromagnetic environment, the overall gateway power supply status, and pending traffic in a future period.

The severity of the overall electromagnetic environment refers to a general electromagnetic interference level affecting the performance of all heterogeneous gateways. For example, the severity of the overall electromagnetic environment may be measured by a general decline in the amplitude of real-time composite scores of all heterogeneous gateways.

The overall gateway power supply status refers to an average or overall remaining power situation of all heterogeneous gateways in the tree network. For example, the overall gateway power supply status may be reflected by a general power shortage of remaining power of a majority of heterogeneous gateways in the network.

In some embodiments, the routing node in the perception control platform continuously monitors the severity of overall electromagnetic environment, the overall gateway power supply status, and the pending traffic in the future period. For example, the routing node may receive signal-to-noise ratio (SNR) data or real-time composite score data of all heterogeneous gateways, calculate an SNR mean value or count a general decline amplitude of the real-time composite scores to evaluate the severity of overall electromagnetic environment. As another example, the routing node may collect remaining power information of all heterogeneous gateways and determine the overall gateway power supply status by calculating an average value of the remaining power information. As another example, the routing node may predict the pending traffic in the future period according to the traffic prediction model.

In some embodiments, in response to an increase in the severity of the overall electromagnetic environment (e.g., a general decline in real-time composite scores of all gateways), the routing node lowers the second preset threshold. This lowering aims to allow heterogeneous gateways with slightly lower scores to also participate in transmission, thereby avoiding transmission interruption caused by overly strict screening criteria in an extremely harsh environment. For example, the routing node may calculate a first adjustment coefficient. The first adjustment coefficient is positively correlated with the general decline amplitude of real-time composite scores of all heterogeneous gateways, and the first adjustment coefficient is used to adjust the second preset threshold during adjustment. The first adjustment coefficient is a value between 0 and 1.

In some embodiments, in response to a poor overall gateway power supply status (e.g., a general power shortage of remaining power of a majority of gateways), the routing node raises the second preset threshold. This raising aims to preferentially select heterogeneous gateways with relatively sufficient power to perform tasks, thereby extending the overall lifespan of the tree network. For example, the routing node may calculate a second adjustment coefficient. The second adjustment coefficient is positively correlated with a mean value of remaining power of all gateways, and the second adjustment coefficient is used to adjust the second preset threshold during adjustment. The second adjustment coefficient is a value between 0 and 1.

In some embodiments, in response to an increase in predicted pending traffic in the future period (e.g., an impending traffic peak), the routing node lowers the second preset threshold. This lowering aims to enable more heterogeneous gateways to share the huge traffic that is about to arrive, preventing local congestion. For example, the routing node may calculate a third adjustment coefficient. The third adjustment coefficient is positively correlated with a change amplitude of the pending traffic in the future period, and the third adjustment coefficient is used to adjust the second preset threshold during adjustment. The third adjustment coefficient is a value between −1 and 1.

In some embodiments, the adjusted second preset threshold may be determined by the first adjustment coefficient, the second adjustment coefficient, and the third adjustment coefficient. For example, the adjusted second preset threshold may be calculated by the following formula:

$${T}_{2}^{′} = {T}_{2} \times ( 3 - {c}_{1} + {c}_{2} - {c}_{3} ) / 3$$

where T₂′ represents the adjusted second preset threshold, T₂ represents the second preset threshold before adjustment, and c₁, c₂, and c₃ represent the first adjustment coefficient, the second adjustment coefficient, and the third adjustment coefficient, respectively.

In some embodiments of the present disclosure, through dynamic adjustment of the second preset threshold, the system can possess an adaptive capability to environmental changes. This ensures that in extremely harsh or high-load situations, the system can enable more heterogeneous gateways to share traffic, avoiding transmission interruption. In a normal state, the system can maintain a high standard to guarantee transmission quality, significantly improving transmission robustness and efficiency.

In some embodiments, the routing node further allocates the data fragments to different heterogeneous gateways in the available gateway set according to the data type of the data fragments.

In some embodiments, the perception control platform may be further configured to, in response to the mechanical data corresponding to the frequency signal being the key mechanical data, allocate the data fragments to a plurality of first gateways with the real-time composite score higher than the second preset threshold; in response to the mechanical data corresponding to the frequency signal being the ordinary mechanical data, allocate the data fragments to a plurality of second gateways with the real-time composite score higher than the second preset threshold.

The first gateway refers to a heterogeneous gateway with characteristics of high bandwidth, low latency, and high reliability. The second gateway refers to a heterogeneous gateway with lower operating costs and higher local bandwidth. For example, the first gateway may be a 5G gateway or a 4G gateway, and the second gateway may be a WiFi gateway.

In some embodiments, for data fragments determined by the routing node as the key mechanical data, the routing node preferentially allocates the data fragments to the plurality of first gateways with the real-time composite score higher than the second preset threshold for transmission. This is because the first gateway has characteristics of high bandwidth, low latency, and high reliability, and is most suitable for transmitting abnormal data requiring urgent processing. By allocating the data fragments to a plurality of high-scoring gateways, multi-path redundant transmission and acceleration of the key data are achieved. For example, the routing node may send the key mechanical data fragments simultaneously or alternately to two or three first gateways with the highest scores to maximize the transmission speed and reliability.

In some embodiments, for data fragments determined by the routing node as ordinary mechanical data, the routing node preferentially allocates the data fragments to a plurality of second gateways with a real-time composite score higher than the second preset threshold for transmission. This is because the second gateway typically has lower operating cost and higher local bandwidth, and is suitable for carrying a large amount of periodic data, thereby reserving valuable first gateway resources for key data and achieving refined scheduling of network resources. For example, the routing node may allocate data fragments of the ordinary mechanical data to a second gateway with a relatively high score to complete transmission in a cost-effective manner.

In some embodiments of the present disclosure, the routing node performs a weighted calculation on the real-time composite score of the heterogeneous gateway based on the status information of the heterogeneous gateway, thereby achieving precise evaluation of the service quality of the gateway. On this basis, the differentiated transmission can be performed according to the priority of the data (the key mechanical data or the ordinary mechanical data) and the score of the heterogeneous gateway, ensuring that high-priority data is transmitted back through the fastest and most reliable path, while low-priority data uses a cost-effective channel, maximizing resource utilization of the heterogeneous network, optimizing transmission efficiency and reliability, and achieving refined data scheduling based on service quality.

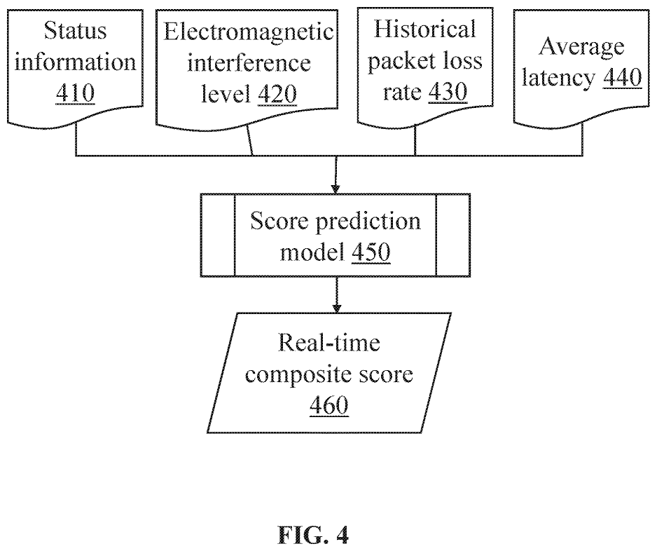

FIG. 4 is a schematic diagram illustrating an exemplary score prediction model according to some embodiments of the present disclosure.

In some embodiments, the perception control platform is further configured to determine a real-time composite score 460 of a heterogeneous gateway based on a score prediction model 450. An input of the score prediction model 450 includes status information 410 of the heterogeneous gateway, an electromagnetic interference level 420 of a region, a historical packet loss rate 430 of at least one set of heterogeneous gateways, and an average latency 440. The score prediction model 450 is a machine learning model. More descriptions regarding the status information 410 of the heterogeneous gateway may be found in step 240 and related content. More descriptions regarding the real-time composite score 460 may be found in the related content above.

The electromagnetic interference level of the region is a measurement indicator of the environmental severity of a physical location where the heterogeneous gateway is located. In some embodiments, the electromagnetic interference level of the region may be a signal-to-noise ratio (SNR). A low SNR means that the heterogeneous gateway has a high potential risk of packet loss. The routing node in the perception control platform may obtain the electromagnetic interference level of the region, for example, an SNR value, by monitoring or obtaining the electromagnetic interference level from other sensors.

The historical packet loss rate is a measurement indicator of the actual reliability of the heterogeneous gateway in historical transmission tasks. In some embodiments, the historical packet loss rate may be a packet loss rate in historical transmission tasks. The transmission task refers to a task of transmitting data performed by the heterogeneous gateway. In some embodiments, the historical transmission tasks may be obtained based on historical operation logs. The historical packet loss rate may be obtained based on historical data. More descriptions regarding the historical operation logs may be found in FIG. 1 and the related description thereof.

The average latency is a measurement indicator of the actual transmission speed of the heterogeneous gateway in historical transmission tasks. In some embodiments, the average latency may be an average value of latencies in historical transmission tasks, i.e., obtained through historical transmission tasks.

The score prediction model 450 refers to a model for determining the real-time composite score of the heterogeneous gateway. In some embodiments, the score prediction model is a machine learning model. For example, the score prediction model may be one or more of a neural network (NN), a deep neural network (DNN), or the like.

In some embodiments, an input of the score prediction model may include the status information of the heterogeneous gateway, an electromagnetic interference level of a region, the historical packet loss rate of the at least one set of heterogeneous gateways, and the average latency. An output of the score prediction model may include the real-time composite score of the heterogeneous gateway.

In some embodiments, the score prediction model may be obtained by training based on training data. In some embodiments, the perception control platform may obtain a second training sample set composed of a plurality of second training samples with second labels, and perform multiple rounds of iterations based on the second training sample set.

The second training sample may include sample status information of the heterogeneous gateway, a sample electromagnetic interference level of the region, a sample historical packet loss rate of at least one set of heterogeneous gateways, and a sample average latency. The second label is a real-time composite score corresponding to the second training sample. The second training sample and the second label may be obtained through historical data.

In some embodiments, the perception control platform may read data of a plurality of historical transmission tasks in historical operation logs, construct the second training sample based on historical status information of the heterogeneous gateway, a historical electromagnetic interference level of the region, a historical packet loss rate and an average latency of at least one set of historical heterogeneous gateways; obtain a plurality of historical transmission tasks meeting similar conditions from the historical data, and set a value of the second label based on an average latency and a packet loss rate of the historical transmission tasks. The value of the second label is negatively correlated with the average latency and the packet loss rate of the historical transmission tasks. For example, scores corresponding to ranges of different average latencies and ranges of packet loss rates are constructed based on experience, and an average value of scores of a plurality of historical transmission tasks corresponding to the same second training sample is used as the second label.

The training process of the score prediction model is similar to that of the traffic prediction model.

In some embodiments of the present disclosure, by introducing the score prediction model and using the status information of the heterogeneous gateway, the electromagnetic interference level of the region, the historical packet loss rate, and the average latency as model inputs, precise prediction of the real-time composite score of the heterogeneous gateway is achieved, upgrading the gateway score from a simple snapshot of a “current status” to a prediction of future transmission performance, significantly improving the intelligence level and reliability of the routing node in selecting an optimal transmission path, thereby optimizing efficiency and robustness of data transmission.

In step 240, status information of the heterogeneous gateways is broadcast according to a preset period.

The status information refers to key parameters periodically broadcast by the heterogeneous gateway. For example, the status information includes a CPU load rate, a signal strength, and a remaining battery level of the heterogeneous gateway. The CPU load rate may measure the busyness level of the heterogeneous gateway.

The preset period refers to a preset time interval for the heterogeneous gateway to perform broadcasting. For example, the preset period may be 5 seconds, 1 minute, or the like.

In some embodiments, the heterogeneous gateway in the sensing network platform may periodically collect the status information of the heterogeneous gateway, for example, a current CPU load rate, a signal strength between the heterogeneous gateway and the routing node, and a remaining battery level of the heterogeneous gateway. The CPU load rate is used to measure the busyness level of the heterogeneous gateway. The signal strength is used to reflect the link quality between a heterogeneous gateway and the routing node. The remaining power is used to reflect the power supply status of the heterogeneous gateway. For example, the heterogeneous gateway may use various sensors and modules integrated inside the heterogeneous gateway (e.g., a power management unit, a central processing unit (CPU) monitoring unit, and a wireless module) to obtain the status information.

In some embodiments, the sensing network platform (e.g., the heterogeneous gateway) encapsulates the status information into a beacon packet and broadcasts the beacon packet to all routing nodes at a preset period. In some embodiments, a broadcast period of the status information may be dynamically adjusted according to network congestion or a gateway load. The routing node may select an optimal transmission path according to the status information received from the heterogeneous gateway.

In some embodiments of the present disclosure, the sensing network platform periodically broadcasts the status information, including an operating status of a heterogeneous gateway, which provides a real-time decision-making basis for the routing node to dynamically select an optimal data transmission path. Such a mechanism optimizes network resource allocation, achieves load balancing, and effectively improves the efficiency and reliability of data transmission.

In step 250, the frequency signal is parsed from the received data fragments, the frequency signal is converted back to the mechanical data, and the mechanical data is sent to the management platform.

In some embodiments, after a data processing module built in the heterogeneous gateway in the sensing network platform receives data fragments, the data processing module first checks a check code and a sequence number encapsulated in a header of the data fragments to ensure the integrity and order of the data fragments. Subsequently, the data processing module parses a payload portion of the data fragments to extract an original frequency signal sent by the perception control platform from the payload portion. For example, the message queuing telemetry transport (MQTT) data processing module of the heterogeneous gateway may decapsulate received data fragments according to a predefined communication protocol to separate the frequency signal data in the data fragments.

In some embodiments, a data processing module of the heterogeneous gateway stores a calibration curve or a conversion formula for each type of sensor, and the data processing module looks up or calculates in real time according to a parsed frequency signal to accurately convert the frequency signal into corresponding readable mechanical data in engineering. For example, a frequency value is converted into a specific axial force (kN) or torque (N·m). For example, for a vibrating wire axial force meter, a heterogeneous gateway uses a pre-stored frequency-force relationship polynomial or lookup table to convert a received vibration frequency (Hz) into a corresponding axial load (kN).

In some embodiments, the heterogeneous gateway uses a plurality of wide area network protocols supported by the heterogeneous gateway (e.g., 4G, 5G, WiFi, or Ethernet) to send the converted mechanical data to the management platform by selecting a channel with the best current network condition. The heterogeneous gateway may use a plurality of available channels in parallel for transmission. For example, if the heterogeneous gateway supports both 4G and WiFi connections, the heterogeneous gateway preferentially or simultaneously sends data via WiFi when a WiFi signal is strong, and the network load is low.

In step 260, data reassembly and an integrity check are performed on the received mechanical data.

In some embodiments, the management platform receives the mechanical data transmitted from the sensing network platform. The mechanical data includes a unique identifier of the data packet and sequence numbers of the data fragments. The management platform first collects mechanical data fragments belonging to the same data packet into a buffer region according to the unique identifier of the data packet. For example, the management platform may maintain a hash table, use the unique identifier of the data packet as a key, and store received fragments in a corresponding list. Subsequently, the management platform sorts the fragments according to the sequence numbers of the data fragments to complete the reassembly of the original mechanical data. For example, the management platform may use an insertion sort algorithm or a quick sort algorithm to rearrange data in the buffer region according to the sequence numbers of fragments to restore the structure of the data packet.

In some embodiments, after completing reassembly of the mechanical data, the management platform performs the integrity check, including a sequence check and a content check.

For the sequence check, the management platform may determine whether the sequence numbers of reassembled data fragments are consecutive to determine whether any fragment is lost during transmission. For example, the management platform may check whether a difference between sequence numbers of adjacent fragments is 1, and if discontinuity occurs, the management platform determines that a fragment is lost and the sequence check fails. As another example, the management platform may know in advance how many fragments the data packet should have, and the management platform quickly detects loss by comparing the number of received fragments with an expected sequence number range.

For the content check, the management platform may use a check code included in the data fragment to verify data content to ensure that the data is not corrupted during transmission. For example, the management platform calculates a cyclic redundancy check (CRC) value of received data and compares the CRC value with a check code encapsulated in a fragment header. If the two are inconsistent, the management platform determines that the data content is corrupted, and the content check fails. As another example, the content check may use a message digest algorithm (e.g., MD5 or SHA-256) to generate a hash value for fragment content and compare the hash value with a hash value calculated by the sending end. In some embodiments, in addition to the sequence number check and the check code verification, the integrity check may also use mechanisms such as an encryption hash function or a digital signature for data traceability and tamper resistance.

In step 270, in response to determining that at least one of a data fragment loss or a check failure is detected, a local retransmission instruction is sent to the perception control platform.

The local retransmission instruction refers to an instruction that only requests retransmission of a specific data fragment with a specific sequence number under a specific globally unique identifier that is missing or damaged, rather than an entire data packet.

In some embodiments, once the management platform detects that the data fragment is lost and/or the check fails (i.e., the sequence check and the content check in step 260 fail), the management platform immediately generates the local retransmission instruction. The local retransmission instruction precisely includes a unique identifier of a data packet corresponding to a missing or corrupted data fragment and a sequence number of the missing or corrupted data fragment, and then the local retransmission instruction is sent back to the perception control platform via a network and sent to a corresponding routing node. For example, if the management platform identifies that fragment No. 5 of data packet ID “XYZ” is lost, the local retransmission instruction explicitly instructs the routing node to retransmit fragment No. 5 of ID “XYZ”. In some embodiments, the local retransmission instruction may also include priority information for retransmission.

In step 280, the complete mechanical data is sent to the computer terminal, and the computer terminal is controlled to render and generate at least one of an axial force trend graph or a torque trend graph.

In some embodiments, after completing reassembly and check of the mechanical data, a server in the management platform stores the complete and accurate mechanical data in a back-end database. Simultaneously, the server pushes the processed mechanical data to a connected computer terminal in real time. For example, the management platform may establish a real-time connection with the computer terminal and send the latest collected axial force and/or torque data from the database to an application on the computer terminal.

In some embodiments, the mechanical data may also be sent to other display devices, such as large-screen displays, virtual reality (VR)/augmented reality (AR) devices, or sent to other analysis systems. The sending manner may also be a message queue or an event-driven publish/subscribe model.

In some embodiments, the management platform may dynamically adjust and supplement a current axial force and/or torque trend graph according to real-time received, reassembled, and checked mechanical data.

The axial force refers to a force acting in an axial direction. For example, the axial force may be measured by a vibrating wire axial force meter.

The torque refers to a moment that causes an object to rotate. For example, the torque may be measured by a torque sensor.

The trend graph refers to a graph that displays the mechanical data over time, with time as a horizontal axis and the mechanical data as a vertical axis. For example, the trend graph may be a line chart or an area chart.

In some embodiments, the server of the management platform sends a rendering instruction and the mechanical data to the computer terminal. After an application running on the computer terminal receives the data and the instruction, the application uses a graphics processing unit (GPU) and a display engine of the computer terminal to render the received axial force data and/or torque data into a real-time dynamic trend graph according to a preset template and display logic, and presents the real-time dynamic trend graph on a user interface. For example, the application of the computer terminal may use a graphics library such as ECharts or Plotly to draw a time-series axial force variation curve and a time-series torque variation curve based on the mechanical data pushed by the management platform. In some embodiments, in addition to the trend graph, other forms of visual charts may be generated, such as a bar chart, a scatter plot, or a heat map.

In some embodiments of the present disclosure, by converting a physical quantity into a frequency signal with strong anti-interference capability for acquisition and performing strict checks using check codes and sequence numbers at a backend, the reliability of data in a strong interference environment is greatly ensured. By using the data fragmentation strategy and the multi-gateway parallel transmission strategy, the transmission waiting time is significantly reduced. Combined with a local retransmission mechanism, network congestion and unnecessary latency caused by traditional whole-packet retransmission are avoided, and the real-time performance of the key mechanical data is ensured. Furthermore, by utilizing a design of heterogeneous gateways and a beacon mechanism, the system can dynamically select an optimal path, optimize network resource allocation, and achieve load balancing.

It should be noted that the description of the process 200 above is merely for illustration and explanation, and does not limit the scope of application of the present disclosure. For those skilled in the art, various modifications and changes may be made to the process 200 under the guidance of the present disclosure. However, these modifications and changes are still within the scope of the present disclosure.

Some embodiments of the present disclosure provide a non-transitory computer-readable storage medium, the storage medium stores computer instructions that, when executed by a processor, cause the processor to implement the multi-gateway collaborative mechanical data monitoring method for sensors according to any embodiment of the present disclosure.

Having described the basic concepts, it is clear to those skilled in the art that the above detailed disclosure is merely exemplary and does not constitute a limitation on the present disclosure. Although not explicitly stated herein, those skilled in the art may make various modifications, improvements, and corrections to the present disclosure. Such modifications, improvements, and corrections are suggested in the present disclosure and therefore still fall within the spirit and scope of the exemplary embodiments of the present disclosure.

Meanwhile, the present disclosure uses specific words to describe the embodiments of the present disclosure. Terms such as “one embodiment,” “an embodiment,” and/or “some embodiments” mean that a certain feature, structure, or characteristic is related to at least one embodiment of the present disclosure. Therefore, it should be emphasized and noted that “an embodiment” or “one embodiment” or “an alternative embodiment” mentioned two or more times in different places in the present disclosure does not necessarily refer to the same embodiment. In addition, certain features, structures, or characteristics in one or more embodiments of the present disclosure may be appropriately combined.

Furthermore, unless explicitly stated in the claims, the order of processing elements and sequences, the use of numbers and letters, or the use of other names in the present disclosure are not intended to limit the order of processes and methods of the present disclosure. Although the above disclosure discusses some embodiments of the invention currently considered useful through various examples, it should be understood that such details are for illustrative purposes only, and the appended claims are not limited to the disclosed embodiments. On the contrary, the claims are intended to cover all modifications and equivalent combinations that conform to the essence and scope of the embodiments of the present disclosure. For example, although the implementation of various components described above may be embodied in a hardware device, it may also be implemented as a software-only solution, e.g., an installation on an existing server or mobile device.

Similarly, it should be noted that, in order to simplify the expression of the disclosure of the present disclosure and thereby help the understanding of one or more embodiments of the invention, in the description of the embodiments of the present disclosure, multiple features are sometimes grouped into one embodiment, drawing, or description thereof. However, this disclosure method does not mean that the object of the present disclosure requires more features than those mentioned in the claims. Rather, claimed subject matter may lie in less than all features of a single foregoing disclosed embodiment.

In some embodiments, numbers describing quantities of ingredients or properties are used. It should be understood that such numbers used in the description of embodiments are modified by terms such as “about,” “approximately,” or “substantially” in some examples. Unless otherwise stated, “about,” “approximately,” or “substantially” indicates that the stated number allows a variation of +20%. Accordingly, in some embodiments, numerical parameters used in the specification and claims are approximate values, which may vary according to the characteristics required by individual embodiments. In some embodiments, numerical parameters should consider the specified number of significant digits and adopt the method of general digit retention. Although numerical ranges and parameters used to confirm the breadth of their scope in some embodiments of the present disclosure are approximate values, in specific embodiments, the setting of such numerical values is as precise as possible within a feasible range.

For each patent, patent application, patent application publication, and other material, such as articles, books, specifications, publications, documents, etc., cited in the present disclosure, the entire content thereof is hereby incorporated into the present disclosure by reference. Excluded are application history documents that are inconsistent with or conflict with the content of the present disclosure, and also excluded are documents (currently or later attached to the present disclosure) that limit the broadest scope of the claims of the present disclosure. It should be noted that if the description, definition, and/or use of terms in the attached materials of the present disclosure are inconsistent with or conflict with the description, definition, and/or use of terms in the present disclosure, the description, definition, and/or use of terms in the present disclosure shall prevail.

Finally, it should be understood that the embodiments described in the present disclosure are only used to illustrate the principles of the embodiments of the present disclosure. Other variations may also fall within the scope of the present disclosure. Therefore, as examples and not limitations, alternative configurations of the embodiments of the present disclosure may be considered consistent with the teachings of the present disclosure. Accordingly, the embodiments of the present disclosure are not limited to the embodiments explicitly introduced and described in the present disclosure.

What is claimed is:

1. A multi-gateway collaborative mechanical data monitoring Internet of Things system for sensors, comprising: a perception control platform, a sensing network platform, and a management platform, wherein the perception control platform includes at least one set of non-contact sensors deployed on a driving shaft or a supporting shaft, the at least one set of non-contact sensors form a tree network, the sensing network platform includes at least one set of heterogeneous gateways supporting different transmission protocols, and the management platform includes a computer terminal, wherein:
the perception control platform is configured to:
collect mechanical data through leaf nodes of the tree network, and convert the mechanical data of each leaf node into a frequency signal,
aggregate frequency signals through routing nodes of the tree network, and segment a data packet containing the frequency signals into a plurality of data fragments of a preset length, and
send the plurality of data fragments to the sensing network platform;
the sensing network platform is configured to:
broadcast status information of the at least one set of heterogeneous gateways according to a preset period, and
parse the frequency signals from the received data fragments, convert the frequency signals back to the mechanical data, and send the mechanical data to the management platform; and
the management platform is configured to:
perform data reassembly and an integrity check on the received mechanical data;
in response to determining that at least one of a data fragment loss or a check failure is detected, send a local retransmission instruction to the perception control platform, and
send complete mechanical data to the computer terminal, and control the computer terminal to render and generate at least one of an axial force trend graph or a torque trend graph.

2. The multi-gateway collaborative mechanical data monitoring Internet of Things system according to claim 1, wherein the perception control platform is further configured to:
determine a data type of the mechanical data corresponding to the frequency signal of each leaf node according to a frequency value of the frequency signal, wherein the data type includes key mechanical data and ordinary mechanical data.

3. The multi-gateway collaborative mechanical data monitoring Internet of Things system according to claim 2, wherein the perception control platform is further configured to:
in response to the frequency value of the frequency signal being greater than a first preset threshold, mark the mechanical data corresponding to the frequency signal as the key mechanical data; and
in response to the frequency value of the frequency signal being less than or equal to the first preset threshold, mark the mechanical data corresponding to the frequency signal as the ordinary mechanical data.

4. The multi-gateway collaborative mechanical data monitoring Internet of Things system according to claim 3, wherein the first preset threshold is dynamically adjusted according to an environmental drift component, and the perception control platform is further configured to:
obtain a median value of frequency variation of the at least one set of non-contact sensors, and determine the environmental drift component; and
update the first preset threshold according to the environmental drift component.

5. The multi-gateway collaborative mechanical data monitoring Internet of Things system according to claim 2, wherein the perception control platform is further configured to:
in response to a determination that the data type of the mechanical data corresponding to the frequency signal is the key mechanical data, send a frequency conversion control instruction to the leaf node that collects the mechanical data, and control the leaf node to switch from a low-frequency mode to a high-frequency mode to collect physical deformation details of at least one of the supporting shaft or the driving shaft.

6. The multi-gateway collaborative mechanical data monitoring Internet of Things system according to claim 2, wherein the perception control platform is further configured to:
predict pending traffic in a future period based on a historical traffic sequence and a historical proportion sequence of the key mechanical data by using a traffic prediction model, wherein the traffic prediction model is a time series model; and
adjust the preset length of the plurality of data fragments according to the pending traffic in the future period.

7. The multi-gateway collaborative mechanical data monitoring Internet of Things system according to claim 2, wherein the perception control platform is further configured to:
calculate a real-time composite score of the at least one set of heterogeneous gateways by weighting based on the status information of the at least one set of heterogeneous gateways; and
control the plurality of data fragments to perform differentiated transmission based on the real-time composite score.

8. The multi-gateway collaborative mechanical data monitoring Internet of Things system according to claim 7, wherein the perception control platform is further configured to:
in response to a determination that the mechanical data corresponding to the frequency signal is the key mechanical data, allocate the plurality of data fragments to a plurality of first gateways with the real-time composite score higher than a second preset threshold; and
in response to a determination that the mechanical data corresponding to the frequency signal is the ordinary mechanical data, allocate the plurality of data fragments to a plurality of second gateways with the real-time composite score higher than the second preset threshold.

9. The multi-gateway collaborative mechanical data monitoring Internet of Things system according to claim 7, wherein the real-time composite score of the at least one set of heterogeneous gateways is determined based on a score prediction model, an input of the score prediction model includes: the status information of the at least one set of heterogeneous gateways, an electromagnetic interference level of a region, a historical packet loss rate of the at least one set of heterogeneous gateways, and an average latency of the at least one set of heterogeneous gateways, and the score prediction model is a machine learning model.

10. A multi-gateway collaborative mechanical data monitoring method for sensors, wherein the multi-gateway collaborative mechanical data monitoring method is implemented by a multi-gateway collaborative mechanical data monitoring Internet of Things system for sensors, the multi-gateway collaborative mechanical data monitoring Internet of Things system includes a perception control platform, a sensing network platform, and a management platform, the perception control platform includes at least one set of non-contact sensors deployed on a driving shaft or a supporting shaft, the at least one set of non-contact sensors form a tree network, the sensing network platform includes at least one set of heterogeneous gateways supporting different transmission protocols, and the management platform includes a computer terminal, the multi-gateway collaborative mechanical data monitoring method comprising:
collecting mechanical data through leaf nodes of the tree network, and converting the mechanical data of each leaf node into a frequency signal;
aggregating frequency signals through routing nodes of the tree network, and segmenting a data packet containing the frequency signals into a plurality of data fragments of a preset length;
sending, by the perception control platform, the plurality of data fragments to the sensing network platform;
broadcasting status information of the at least one set of heterogeneous gateways according to a preset period;
parsing the frequency signals from the received data fragments, converting the frequency signals back to the mechanical data, and sending the mechanical data to the management platform;
performing data reassembly and an integrity check on the received mechanical data;
in response to determining that at least one of a data fragment loss or a check failure is detected, sending a local retransmission instruction to the perception control platform; and
sending the complete mechanical data to the computer terminal, and controlling the computer terminal to render and generate at least one of an axial force trend graph or a torque trend graph.

11. The multi-gateway collaborative mechanical data monitoring method according to claim 10, further comprising:
determining a data type of the mechanical data corresponding to the frequency signal of each leaf node according to a frequency value of the frequency signal, wherein the data type includes key mechanical data and ordinary mechanical data.

12. The multi-gateway collaborative mechanical data monitoring method according to claim 11, wherein the determining a data type of the mechanical data corresponding to the frequency signal according to a frequency value of the frequency signal comprises:
in response to the frequency value of the frequency signal being greater than a first preset threshold, marking the mechanical data corresponding to the frequency signal as the key mechanical data; and
in response to the frequency value of the frequency signal being less than or equal to the first preset threshold, marking the mechanical data corresponding to the frequency signal as the ordinary mechanical data.

13. The multi-gateway collaborative mechanical data monitoring method according to claim 12, wherein the first preset threshold is dynamically adjusted according to an environmental drift component, and the method further comprises:
obtaining a median value of frequency variation of the at least one set of non-contact sensors, and determining the environmental drift component; and
updating the first preset threshold according to the environmental drift component.

14. The multi-gateway collaborative mechanical data monitoring method according to claim 11, further comprising:
in response to a determination that the data type of the mechanical data corresponding to the frequency signal is the key mechanical data, sending a frequency conversion control instruction to the leaf node that collects the mechanical data, and controlling the leaf node to switch from a low-frequency mode to a high-frequency mode to collect physical deformation details of at least one of the supporting shaft or the driving shaft.

15. The multi-gateway collaborative mechanical data monitoring method according to claim 11, further comprising:
predicting pending traffic in a future period based on a historical traffic sequence and a historical proportion sequence of the key mechanical data by using a traffic prediction model, wherein the traffic prediction model is a time series model; and
adjusting the preset length of the plurality of data fragments according to the pending traffic in the future period.

16. The multi-gateway collaborative mechanical data monitoring method according to claim 11, further comprising:
calculating a real-time composite score of the at least one set of heterogeneous gateways by weighting based on the status information of the at least one set of heterogeneous gateways; and
controlling the plurality of data fragments to perform differentiated transmission based on the real-time composite score.

17. The multi-gateway collaborative mechanical data monitoring method according to claim 16, wherein the controlling the plurality of data fragments to perform differentiated transmission based on the real-time composite score comprises:
in response to a determination that the mechanical data corresponding to the frequency signal is the key mechanical data, allocating the plurality of data fragments to a plurality of first gateways with the real-time composite score higher than a second preset threshold; and
in response to a determination that the mechanical data corresponding to the frequency signal is the ordinary mechanical data, allocating the plurality of data fragments to a plurality of second gateways with the real-time composite score higher than the second preset threshold.

18. The multi-gateway collaborative mechanical data monitoring method according to claim 16, further comprising:
determining the real-time composite score of the at least one set of heterogeneous gateways based on a score prediction model, wherein an input of the score prediction model includes: the status information of the at least one set of heterogeneous gateways, an electromagnetic interference level of a region, a historical packet loss rate of the at least one set of heterogeneous gateways, and an average latency of the at least one set of heterogeneous gateways, and the score prediction model is a machine learning model.

19. The multi-gateway collaborative mechanical data monitoring method according to claim 17, wherein the second preset threshold is dynamically adjusted according to a severity of overall electromagnetic environment, an overall gateway power supply status, and pending traffic in a future period.

20. A non-transitory computer-readable storage medium, wherein the storage medium stores computer instructions, when executed by a processor, the computer instructions cause the processor to implement a multi-gateway collaborative mechanical data monitoring method by a multi-gateway collaborative mechanical data monitoring Internet of Things system for sensors, the multi-gateway collaborative mechanical data monitoring Internet of Things system includes a perception control platform, a sensing network platform, and a management platform, the perception control platform includes at least one set of non-contact sensors deployed on a driving shaft or a supporting shaft, the at least one set of non-contact sensors form a tree network, the sensing network platform includes at least one set of heterogeneous gateways supporting different transmission protocols, and the management platform includes a computer terminal, the multi-gateway collaborative mechanical data monitoring method comprising:
collecting mechanical data through leaf nodes of the tree network, and converting the mechanical data into a frequency signal;
aggregating the frequency signal through routing nodes of the tree network, and segmenting a data packet containing the frequency signal into a plurality of data fragments of a preset length;
sending, by the perception control platform, the plurality of data fragments to the sensing network platform;
broadcasting status information of the at least one set of heterogeneous gateways according to a preset period;
parsing the frequency signal from the received data fragments, converting the frequency signal back to the mechanical data, and sending the mechanical data to the management platform;
performing data reassembly and an integrity check on the received mechanical data;
in response to determining that at least one of a data fragment loss or a check failure is detected, sending a local retransmission instruction to the perception control platform; and
sending the complete mechanical data to the computer terminal, and controlling the computer terminal to render and generate at least one of an axial force trend graph or a torque trend graph.
